(19) United States
(12) Patent Application Publication
(10) Pub. No.: US 2025/0207910 A1
(43) Pub. Date: Jun. 26, 2025

(54) Optical Sensor and Method for use in Detecting the Deposition of Material from a Fluid

(71) Applicant: University of York, York (GB)

(72) Inventors: Thomas Fraser-Krauss, York (GB); Kezheng Li, York (GB); Christopher Reardon, York (GB); Steve Johnson, York (GB)

(21) Appl. No.: 18/850,477

(22) PCT Filed: Mar. 24, 2023
(86) PCT No.: PCT/GB2023/050748

§ 371 Date: Sep. 24, 2024

(30) Foreign Application Priority Data
Mar. 25, 2022 (GB) 2204262.6

(51) Int. Cl. G01B 11/06; G06T 7/00; H04N 23/54; H04N 23/56; H04N 23/60; H04N 23/74

(52) U.S. Cl. CPC G01B 11/0683; G06T 7/0014; H04N 23/54; H04N 23/56; H04N 23/64; H04N 23/74; G06T 2207/30108

(57) ABSTRACT

An optical sensor, an optical sensor system, and associated methods are disclosed for use in detecting the deposition of material such as a biofilm comprising bacteria from a fluid such as a flow of fluid or a static fluid over a time period of greater than or equal to one hour. The optical sensor comprises a chirped grating structure defining a sensing surface for exposure to the fluid and for receiving material deposited from the fluid. The chirped grating structure is configured such that when the chirped grating structure is illuminated with a beam of light, one or more corresponding guided mode resonances are excited in one or more corresponding different regions of the chirped grating structure thereby causing the one or more corresponding different regions of the chirped grating structure to reflect one or more corresponding spatial portions of the beam of light. The positions of the one or more corresponding different regions of the chirped grating structure in which the one or more corresponding guided mode resonances are excited depend on a refractive index of a material to which the sensing surface is exposed and/or a refractive index and a thickness of a material which is deposited on the sensing surface from the fluid.

### FIELD

The present disclosure relates to an optical sensor, an optical sensor system, and associated methods for use in detecting the deposition of material from a fluid such as a flow of fluid or a static fluid and, in particular though not exclusively, for use in detecting the deposition of a biofilm comprising bacteria from a flow of fluid in a fluid conduit such as a fluid conduit of an industrial processing or manufacturing system or a fluid conduit of a medical device or a fluid conduit of a medical system, or for use in detecting the deposition of a biofilm comprising bacteria from a fluid in a fluid vessel, a fluid reservoir, or a fluid tank.

### BACKGROUND

Detecting the presence of bacteria in process flows in open or closed systems, for example in industrial process pipes, is extremely important to manufacturers in many industries, such as the home and personal care product market, food and drink as well as pharma because bacterial contamination requires extensive cleaning procedures with corresponding plant downtime and product recalls. Currently, it is common practice in these industries to conduct regular microbial tests that may take up to three days, thereby causing significant delays. Moreover, the microbial tests may be poorly predictive of contamination e.g. due to inability to culture bacteria and/or due to small sample volumes. Furthermore, current sampling methods cannot detect the presence of bacteria in a flow of fluid or within the fluid conduit.

### SUMMARY

According to an aspect of the present disclosure there is provided an optical sensor for use in detecting the deposition of material from a fluid over a time period of greater than or equal to one hour, the optical sensor comprising:
a chirped grating structure, the chirped grating structure defining a sensing surface for exposure to the fluid and for receiving material deposited from the fluid,
wherein the chirped grating structure is configured such that when the chirped grating structure is illuminated with a beam of light, one or more corresponding guided mode resonances are excited in one or more corresponding different regions of the chirped grating structure thereby causing the one or more corresponding different regions of the chirped grating structure to reflect one or more corresponding spatial portions of the beam of light,
wherein the positions of the one or more corresponding different regions of the chirped grating structure in which the one or more corresponding guided mode resonances are excited depend on a refractive index of a material to which the sensing surface is exposed and/or a refractive index and a thickness of a material which is deposited on the sensing surface from the fluid.

Such an optical sensor may be suitable for use in detecting the deposition or monitoring the build-up of a material on the sensing surface over a time period of greater than or equal to one day, greater than or equal to one week, or greater than or equal to one month. Such an optical sensor may also be suitable for use in detecting the deposition or monitoring the build-up of a material on the sensing surface over a time period of less than one hour. Such an optical sensor may be suitable for detecting the deposition or monitoring the build-up of a material on the sensing surface from a fluid, for example from a flow of fluid or from a static fluid. For example, such an optical sensor may suitable for monitoring the build-up of a material such as a biofilm comprising bacteria on the sensing surface. The sensing surface may form part of an interior surface of a fluid conduit such as a fluid conduit of an industrial processing or manufacturing system or a fluid conduit of a medical device such as a catheter or a fluid conduit of a medical system. The sensing surface may form part of an interior surface of a fluid vessel, a fluid reservoir, or a fluid tank.

Optionally, the chirped grating structure comprises a plurality of different grating structures, each grating structure having a different grating period in one or two directions and/or a different fill-factor in one or two directions.

Optionally, the chirped grating structure has a grating period and/or a fill-factor which varies in one or two directions over at least part of the chirped grating structure, for example which varies continuously in one or two directions over at least part of the chirped grating structure.

Optionally, the chirped grating structure comprises a dual-chirped grating structure comprising first and second opposing chirped gratings, wherein the first chirped grating has a grating period and/or a fill-factor which increases in a first direction which extends away from the second chirped grating and the second chirped grating has a grating period and/or a fill-factor which increases in a second direction which extends away from the first chirped grating, wherein the second direction is opposite to the first direction. Such an optical sensor may be used to at least partially reduce the impact of, or to at least partially correct for the effects of, any misalignment of the optical sensor relative to the beam of light and/or relative to an image sensor used to capture an image of the one or more corresponding guided mode resonances excited in one or more corresponding different regions of the chirped grating structure which may be caused by mechanical vibrations and/or alignment drift over a time period of greater than or equal to one hour, for example in an environment such as an industrial processing or manufacturing environment. This may in turn improve the accuracy of detection of the deposition of material from the fluid in the fluid conduit over a time period of greater than or equal to one hour, for example in an environment such as an industrial processing or manufacturing environment.

Optionally, the first chirped grating has a grating period and/or a fill-factor which increases continuously in the first direction and the second chirped grating has a grating period and/or a fill-factor which increases continuously in the second direction.

Optionally, the dual-chirped grating structure is symmetrical about a line of symmetry which extends between the first and second opposing chirped gratings.

Optionally, the material to be detected comprises one or more particles such as one or more dielectric particles and/or one or more bacteria and the chirped grating structure is configured such that each corresponding guided mode resonance has a dimension which is greater than or equal to a dimension of the particles and less than or equal to twenty times the dimension of the particles, which is greater than or equal to twice a dimension of the particles and less than or equal to fifteen times the dimension of the particles, which is approximately equal to, or which is equal to, ten times the dimension of the particles.

Configuring the chirped grating structure so that the dimension of the guided mode resonance is sufficiently large may result in the guided mode resonance interacting with many particles. This may result in the guided mode resonance moving smoothly or progressively as the number of particles deposited on the sensing surface increases, thereby allowing the number of particles deposited on the sensing surface and/or the concentration of particles in the fluid to be accurately determined from the size of the spatial shift in the guided mode resonance. If, however, a dimension of the guided mode resonance were comparable to a dimension of the particles, then the shift in the guided mode resonance may be very localised leading to “hotspots” where the guided mode resonance changes in some regions of the chirped grating structure adjacent to the particles but not in others and resulting in a guided mode resonance that is noisy and/or which jumps around. This may have the effect of reducing the accuracy with which the size of the spatial shift in the guided mode resonance may be determined and of reducing the accuracy with which the number of particles deposited on the sensing surface and/or the concentration of particles in the fluid may be determined. Conversely, if the dimension of the guided mode resonance were much greater than ten times the dimension of the particles, the sensitivity of the sensor may be reduced. Consequently, such a chirped grating structure may provide a good compromise between accuracy and sensitivity. Such a chirped grating structure may, in particular, be well suited for measuring a sub-monolayer of particles such as a sub-monolayer of bacteria and/or a sub-monolayer biofilm over a time period of greater than or equal to one hour.

Optionally, the chirped grating structure is configured such that each corresponding guided mode resonance has a dimension of at least 5 μm, at least 10 μm, at least 20 μm, at least 50 μm, or at least 100 μm.

Optionally, the optical sensor comprises a substrate, wherein the chirped grating structure is disposed on, formed on, or defined in, a surface of the substrate.

Optionally, the chirped grating structure comprises one or more gratings.

Optionally, the one or more gratings are formed in a material which is disposed on, or formed on, the surface of the substrate.

Optionally, the one or more gratings comprise, or are formed from, a material which has a higher refractive index than the material of which the substrate comprises or is formed, and which has a higher refractive index than the material to be detected.

Optionally, the substrate and the one or more gratings comprise, or are formed from, different materials.

Optionally, the substrate comprises, or is formed from, silica (SiO₂).

Optionally, the one or more gratings comprise, or are formed from, silicon nitride (Si₃N₄).

Optionally, the one or more gratings comprise, or are formed from, silicon.

Optionally, the one or more gratings define the sensing surface.

Optionally, the chirped grating structure comprises an outer protective film which defines the sensing surface.

Optionally, the protective film covers the one or more gratings.

Optionally, the protective film is configured to provide chemical and/or mechanical protection of the underlying one or more gratings. This may be particularly important where the chirped grating structure is exposed to harsh environmental conditions over a time period of greater than or equal to one hour, for example wherein at least one of: the fluid is at a high temperature and/or pressure, the fluid is corrosive, the fluid contains particulates, the fluid is flowing at a high rate, and the optical sensor and/or the fluid is exposed to mechanical vibrations.

Optionally, the protective film is formed by atomic layer deposition (ALD).

Optionally, the protective film is continuous and/or pin-hole free.

Optionally, the protective film is thick enough to provide a sufficient degree of chemical and/or mechanical protection of the one or more underlying gratings, but not so thick so as to unduly reduce the sensitivity of the resonant wavelength of the optical sensor to the refractive index of the material to which the sensing surface is exposed and/or to the refractive index and thickness of the material which is deposited on the sensing surface from the fluid.

Optionally, the protective film has a thickness of 1 μm or less, 500 nm or less, 100 nm or less, 50 nm or less, 20 nm or less, or 10 nm or less.

Optionally, the protective film comprises, or is formed from, a single material.

Optionally, the protective film comprises a plurality of layers.

Optionally, the protective film comprises a first layer of a first material and a second layer of a second material.

Optionally, the protective film comprises a plurality of layers of a first material alternating with a plurality of layers of a second material.

Optionally, the protective film comprises more than two different materials.

Optionally, the protective film comprises Al₂O₃, for example wherein the first material comprises Al₂O₃.

Optionally, the protective film comprises ZrO₂, for example wherein the second material comprises ZrO₂.

Optionally, the protective film comprises a layer of Al₂O₃ and a layer of ZrO₂, for 25 example a 3 nm-thick layer of Al₂O₃ and a 3 nm-thick layer of ZrO₂.

Optionally, the optical sensor comprises a layer of one or more binding agents, binding materials or binding molecules such as one or more antibodies or one or more polymer films on the sensing surface of the optical sensor. Optionally, the chirped grating structure comprises a measurement chirped grating structure and the optical sensor further comprises a reference chirped grating structure defining a reference sensing surface for exposure to the fluid and for receiving material deposited from the fluid, wherein the reference chirped grating structure comprises one or more gratings, wherein the one or more gratings of the reference chirped grating structure are nominally identical to the one or more gratings of the measurement chirped grating structure, wherein the reference chirped grating structure further comprises an outer protective film which covers the one or more underlying gratings of the reference chirped grating structure and which defines the reference sensing surface, and wherein the outer protective films of the measurement and reference chirped grating structures are configured so that a position of a guided mode resonance in the measurement chirped grating structure is more sensitive, and preferably much more sensitive, to changes in the thickness and/or refractive index of the material to which the sensing surface is exposed and a position of a guided mode resonance in the reference chirped grating structure is less sensitive, and preferably much less sensitive, to changes in the thickness and/or refractive index of the material to which the reference sensing surface is exposed.

Optionally, the protective film of the measurement chirped grating structure is thinner than the outer protective film of the reference chirped grating structure so that a position of a guided mode resonance in the measurement chirped grating structure is more sensitive, and preferably much more sensitive, to changes in the thickness and/or refractive index of the material to which the sensing surface is exposed and a position of a guided mode resonance in the reference chirped grating structure is less sensitive, and preferably much less sensitive, to changes in the thickness and/or refractive index of the material to which the reference sensing surface is exposed.

Optionally, the chirped grating structure comprises a measurement chirped grating structure and the optical sensor further comprises a reference chirped grating structure defining a reference sensing surface for exposure to the fluid and for receiving material deposited from the fluid, wherein the reference chirped grating structure comprises one or more gratings, wherein the one or more gratings of the reference chirped grating structure are nominally identical to the one or more gratings of the measurement chirped grating structure, wherein the reference chirped grating structure further comprises an outer protective film which covers the one or more underlying gratings of the reference chirped grating structure and which defines the reference sensing surface, and wherein the measurement chirped grating structure does not comprise any outer protective film covering the one or more gratings of the measurement chirped grating structure such that the one or more gratings of the measurement chirped grating structure define the sensing surface.

Optionally, the light comprises narrow-band light, for example coherent light.

Optionally, the fluid comprises a fluid in an industrial processing or manufacturing system.

Optionally, the fluid comprises a fluid in a medical device such as a catheter or a fluid in a medical system.

Optionally, the fluid is flowing or static.

Optionally, the fluid is flowing in an open-loop flow of fluid or a closed-loop flow of fluid.

According to an aspect of the present disclosure there is provided an optical sensor system for use in detecting the deposition of material from a fluid over a time period of greater than or equal to one hour, the optical sensor system comprising:
an optical sensor as described above;
an optical source for generating the beam of light for illuminating the chirped grating structure; and
an image sensor for capturing an image of the chirped grating structure when the chirped grating structure is illuminated by the beam of light.

Optionally, the optical source comprises a laser or a filtered LED.

Optionally, the image sensor comprises a CMOS image sensor or a CCD image sensor.

According to an aspect of the present disclosure there is provided a fluid conduit system comprising:
a fluid conduit containing a fluid; and
the optical sensor as described above,
wherein the optical sensor is mounted relative to the fluid conduit so that the sensing surface is exposed to the fluid in the fluid conduit for receiving material deposited from the fluid in the fluid conduit.

Optionally, the fluid conduit comprises part of a fluid conduit line or loop of an industrial processing or manufacturing system.

Optionally, the fluid conduit comprises part of a fluid conduit line or loop of a medical device such as a catheter or the fluid conduit comprises part of a fluid conduit line or loop of a medical system.

Optionally, the fluid conduit system is an open-loop fluid conduit system or a closed-loop fluid conduit system.

Optionally, the fluid conduit comprises a section of a pipe or a section of a pipeline.

According to an aspect of the present disclosure there is provided a fluid vessel system comprising:
a fluid vessel containing a fluid; and
the optical sensor as described above,
wherein the optical sensor is mounted relative to the fluid vessel so that the sensing surface is exposed to the fluid in the fluid vessel for receiving material deposited from the fluid in the fluid vessel.

Optionally, the fluid vessel comprises a fluid reservoir or a fluid tank.

According to an aspect of the present disclosure there is provided a sensor system for use in detecting the deposition of material from a fluid over a time period of greater than or equal to one hour, the sensor system comprising:
the optical sensor system as described above; and
a controller configured to:
control the optical source and the image sensor so that the image sensor captures a plurality of images of the chirped grating structure at a corresponding plurality of image capture times when the chirped grating structure is illuminated by the beam of light;
determine a position of each of the one or more guided mode resonances on the chirped grating structure at each of the image capture times; and
detect, based on the relative positions of each of the one or more guided mode resonances on the chirped grating structure at the plurality of image capture times, a change in a refractive index of a material to which the sensing surface is exposed between any of the image capture times and/or a change in a refractive index and a thickness of a material which is deposited on the sensing surface from the fluid between any of the image capture times.

Optionally, the controller is configured to determine, based on the relative positions of each of the one or more guided mode resonances on the chirped grating structure at the plurality of image capture times, a quantity representative of a magnitude of a change in a refractive index of a material to which the sensing surface is exposed between any of the image capture times and/or a quantity representative of a magnitude of a change in a refractive index and a thickness of a material which is deposited on the sensing surface from the fluid between any of the image capture times.

Optionally, the controller is configured to determine, based on the relative positions of each of the one or more guided mode resonances on the chirped grating structure at the plurality of image capture times in combination with calibration data, a magnitude of the change in a refractive index of a material to which the sensing surface is exposed between any of the image capture times and/or a magnitude of the change in a refractive index and a thickness of a material which is deposited on the sensing surface from the fluid between any of the image capture times.

The calibration data may for example comprise measurements of relative positions of each of the one or more guided mode resonances on the chirped grating structure as a function of a refractive index of a material to which the sensing surface is exposed and/or measurements of relative positions of each of the one or more guided mode resonances on the chirped grating structure as a function of a refractive index and a thickness of a material which is deposited on the sensing surface from the fluid.

Optionally, the controller is configured to control the image sensor so that the image sensor captures the plurality of images of the chirped grating structure at the corresponding plurality of image capture times over a time period of greater than or equal to one minute, greater than or equal to one hour, greater than or equal to one day, greater than or equal to one week, or greater than or equal to one month.

Optionally, the controller is configured to control the image sensor so that the image sensor captures the plurality of images of the chirped grating structure at the corresponding plurality of image capture times at a frequency which is greater than a frequency of any mechanical vibrations of the chirped grating structure relative to the optical source and/or relative to the image sensor.

Optionally, the controller is configured to control the image sensor so that the image sensor captures the plurality of images of the chirped grating structure at the corresponding plurality of image capture times at a frequency which is greater or equal to twice the frequency of any mechanical vibrations of the chirped grating structure relative to the optical source and/or relative to the image sensor.

Optionally, the controller is configured to determine a separation of two guided mode resonances on the chirped grating structure at each image capture time of the plurality of image capture times.

Optionally, the controller is configured to determine a rolling average value of the determined separation of the two guided mode resonances on the chirped grating structure at each image capture time of the plurality of image capture times.

Optionally, the controller is configured to detect, based on the determined separation of the two guided mode resonances or based on the determined rolling average value of the determined separation of the two guided mode resonances, a change in a refractive index of a material to which the sensing surface is exposed between any of the image capture times and/or a change in a refractive index and a thickness of a material which is deposited on the sensing surface from the fluid between any of the image capture times.

Optionally, the controller is configured to determine, based on the determined separation of the two guided mode resonances or based on the determined rolling average value of the determined separation of the two guided mode resonances, a quantity representative of a magnitude of a change in a refractive index of a material to which the sensing surface is exposed between any of the image capture times and/or a quantity representative of a magnitude of a change in a refractive index and a thickness of a material which is deposited on the sensing surface from the fluid between any of the image capture times.

Optionally, the controller is configured to determine, based on calibration data in combination with the determined separation of the two guided mode resonances or based on calibration data in combination with the determined rolling average value of the determined separation of the two guided mode resonances, a magnitude of the change in a refractive index of a material to which the sensing surface is exposed between any of the image capture times and/or a magnitude of the change in a refractive index and a thickness of a material which is deposited on the sensing surface from the fluid between any of the image capture times.

The calibration data may for example comprise measurements of the separation of the two guided mode resonances on the chirped grating structure as a function of a refractive index of a material to which the sensing surface is exposed and/or measurements of the separation of the two guided mode resonances on the chirped grating structure as a function of a refractive index and a thickness of a material which is deposited on the sensing surface from the fluid.

According to an aspect of the present disclosure there is provided a method for use in detecting the deposition of material from a fluid over a time period of greater than or equal to one hour, the method comprising:
exposing a sensing surface of a chirped grating structure to the fluid so that the sensing surface can receive material deposited from the fluid;
illuminating the chirped grating structure with a beam of light so as to excite one or more guided mode resonances in one or more corresponding different regions of the chirped grating structure thereby causing the one or more corresponding different regions of the chirped grating structure to reflect one or more corresponding spatial portions of the beam of light; and
capturing a plurality of images of the chirped grating structure at a corresponding plurality of image capture times when the chirped grating structure is illuminated by the beam of light.

Optionally, the method comprises:
determining a position of each of the one or more guided mode resonances on the chirped grating structure at each of the image capture times; and
detecting, based on the relative positions of each of the one or more guided mode resonances on the chirped grating structure at the plurality of image capture times, a change in a refractive index of a material to which the sensing surface is exposed between any of the image capture times and/or a change in a refractive index and a thickness of a material which is deposited on the sensing surface from the fluid between any of the image capture times.

Optionally, the method comprises determining, based on the relative positions of each of the one or more guided mode resonances on the chirped grating structure at the plurality of image capture times, a quantity representative of a magnitude of a change in a refractive index of a material to which the sensing surface is exposed between any of the image capture times and/or a quantity representative of a magnitude of a change in a refractive index and a thickness of a material which is deposited on the sensing surface from the fluid between any of the image capture times.

Optionally, the method comprises determining, based on the relative positions of each of the one or more guided mode resonances on the chirped grating structure at the plurality of image capture times in combination with calibration data, a magnitude of the change in a refractive index of a material to which the sensing surface is exposed between any of the image capture times and/or a magnitude of the change in a refractive index and a thickness of a material which is deposited on the sensing surface from the fluid between any of the image capture times.

The calibration data may for example comprise measurements of relative positions of each of the one or more guided mode resonances on the chirped grating structure as a function of a refractive index of a material to which the sensing surface is exposed and/or measurements of relative positions of each of the one or more guided mode resonances on the chirped grating structure as a function of a refractive index and a thickness of a material which is deposited on the sensing surface from the fluid.

Optionally, the method comprises capturing the plurality of images of the chirped grating structure at a corresponding plurality of image capture times over a time period of greater than or equal to one day, greater than or equal to one week, or greater than or equal to one month.

Optionally, the method comprises capturing the plurality of images of the chirped grating structure at a corresponding plurality of image capture times at a frequency which is greater than a frequency of any mechanical vibrations of the chirped grating structure relative to an optical source used to illuminate the chirped grating structure and/or relative to an image sensor used to capture the plurality of images of the chirped grating structure.

Optionally, the method comprises capturing the plurality of images of the chirped grating structure at a corresponding plurality of image capture times at a frequency which is greater or equal to twice the frequency of any mechanical vibrations of the chirped grating structure relative to an optical source used to illuminate the chirped grating structure and/or relative to an image sensor used to capture the plurality of images of the chirped grating structure.

Optionally, the method comprises determining a separation of two guided mode resonances on the chirped grating structure at each image capture time of the plurality of image capture times.

Optionally, the method comprises determining a rolling average value of the determined separation of the two guided mode resonances on the chirped grating structure at each image capture time of the plurality of image capture times.

Optionally, the method comprises detecting, based on the determined separation of the two guided mode resonances or based on the determined rolling average value of the determined separation of the two guided mode resonances, a change in a refractive index of a material to which the sensing surface is exposed between any of the image capture times and/or a change in a refractive index and a thickness of a material which is deposited on the sensing surface from the fluid between any of the image capture times.

Optionally, the method comprises determining, based on the determined separation of the two guided mode resonances or based on the determined rolling average value of the determined separation of the two guided mode resonances, a quantity representative of a magnitude of a change in a refractive index of a material to which the sensing surface is exposed between any of the image capture times and/or a quantity representative of a magnitude of a change in a refractive index and a thickness of a material which is deposited on the sensing surface from the fluid between any of the image capture times.

Optionally, the method comprises determining, based on calibration data in combination with the determined separation of the two guided mode resonances or based on calibration data in combination with the determined rolling average value of the determined separation of the two guided mode resonances, a magnitude of the change in a refractive index of a material to which the sensing surface is exposed between any of the image capture times and/or a magnitude of the change in a refractive index and a thickness of a material which is deposited on the sensing surface from the fluid between any of the image capture times.

The calibration data may for example comprise measurements of the separation of the two guided mode resonances on the chirped grating structure as a function of a refractive index of a material to which the sensing surface is exposed and/or measurements of the separation of the two guided mode resonances on the chirped grating structure as a function of a refractive index and a thickness of a material which is deposited on the sensing surface from the fluid.

Optionally, the material to be detected comprises a dielectric material.

Optionally, the material to be detected comprises one or more dielectric particles.

Optionally, the material to be detected comprises a metal.

Optionally, the material to be detected comprises a contaminant such as dirt, sand, grit or the like.

Optionally, the material to be detected comprises organic or inorganic material.

Optionally, the material to be detected comprises one or more proteins.

Optionally, the material to be detected comprises one or more biological organisms, micro-organisms, and/or molecules.

Optionally, the material to be detected comprises one or more cells.

Optionally, the material to be detected comprises bacteria.

Optionally, the material to be detected comprises an extracellular matrix of extracellular polymeric substances.

Optionally, the material to be detected comprises a biofilm. For example, the material to be detected may comprise one or more cells, micro-organisms and/or bacteria embedded in extracellular matrix of extracellular polymeric substances.

Optionally, the fluid comprises a liquid.

Optionally, the fluid comprises one or more chemicals, one or more ingredients, one or more food stuffs, one or more constituents of a food stuff, one or more drinks, one or more constituents of a drink, one or more ingredients or constituents of a chemical or pharmaceutical composition, one or more biological fluids, or one or more bodily fluids.

Optionally, the fluid comprises a hydrocarbon fluid.

Optionally, the material to be detected comprises wax or one or more hydrates.

It should be understood that any one or more of the features of any one of the foregoing aspects of the present disclosure may be combined with any one or more of the features of any of the other foregoing aspects of the present disclosure.

### BRIEF DESCRIPTION OF THE DRAWINGS

A method of detecting the deposition of material from a fluid will now be described by way of non-limiting example only with reference to the drawings of which:

FIG. 1 is a schematic of a sensor system including an optical sensor system in use detecting the deposition of material from a flow of fluid in a fluid conduit;

FIG. 2A shows part of the optical sensor system of FIG. 1 including an optical sensor in use detecting the deposition of material, here bacteria, on a sensing surface of the optical sensor from the flow of fluid through the fluid conduit;

FIG. 2B is a detailed schematic of the optical sensor and the bacteria of FIG. 2A;

FIG. 3A is a schematic of the continuously chirped or fan-out grating structure of the optical sensor of FIG. 2A;

FIG. 3B shows an image of the chirped grating structure of FIG. 3A and a guided mode resonance excited during illumination of the chirped grating structure before exposure of the sensing surface of the chirped grating structure to a flow of media in which bacteria is suspended;

FIG. 3C shows an image of the chirped grating structure of FIG. 3A and a guided mode resonance excited during illumination of the chirped grating structure following a 48 hour exposure of the sensing surface of the chirped grating structure to a flow of media in which bacteria is suspended;

FIG. 3D shows plots of the intensity along the line Y-Y of FIGS. 3B and 3C illustrating the spatial shift in the guided mode resonance as a result of the exposure of the sensing surface of the chirped grating structure to the flow of media in which bacteria is suspended;

FIG. 4A is a schematic of an alternative optical sensor for use in the optical sensor system of FIG. 1;

FIG. 4B shows an image of the optical sensor of FIG. 4A and a guided mode resonance excited during illumination of the chirped grating structure of the optical sensor before exposure of the sensing surface of the chirped grating structure to a flow of media in which bacteria is suspended in a broth;

FIG. 4C shows an image of the optical sensor of FIG. 4A and a guided mode resonance excited during illumination of the chirped grating structure of the optical sensor following a 48 hour exposure of the sensing surface of the chirped grating structure to a flow of media in which bacteria is suspended;

FIG. 5A is a schematic of a further alternative optical sensor for use in the optical sensor system of FIG. 1;

FIG. 5B shows an image of the optical sensor of FIG. 5A and a guided mode resonance excited during illumination of the chirped grating structure of the optical sensor at a first instant in time in the presence of mechanical vibrations of the optical sensor relative to the remainder of the optical sensor system of FIG. 1;

FIG. 5C shows an image of the chirped grating structure of FIG. 5A and a guided mode resonance excited during illumination of the chirped grating structure at a second instant in time in the presence of mechanical vibrations of the optical sensor relative to the remainder of the optical sensor system of FIG. 1;

FIG. 5D shows a plot of the vertical position of the peak intensity of one of the guided mode resonances of FIGS. 5B and 5C along line Y-Y as a function of time, a plot of the vertical separation of the peak intensities of the guided mode resonances of FIGS. 5B and 5C along line Y-Y as a function of time, and a plot of a rolling average of the vertical separation of the peak intensities of the guided mode resonances of FIGS. 5B and 5C along line Y-Y as a function of time;

FIG. 6A is an image of part of a fluid conduit system comprising a fluid conduit and the optical sensor system of FIG. 1;

FIG. 6B is an enlarged image of the part of the fluid conduit system of FIG. 6A;

FIG. 6C shows a reference curve illustrating the measured spatial shift in the guided mode resonance with time during exposure of a sensing surface of an optical sensor of the optical sensor system of FIG. 1 to a control flow of an industrially relevant process liquid and a measurement curve illustrating the spatial shift in the guided mode resonance with time during exposure of the sensing surface of the optical sensor to a flow of the same process liquid including bacteria in a concentration of 1e3 cfu/ml;

FIG. 6D shows a reference curve illustrating the measured spatial shift in the guided mode resonance with time during exposure of a sensing surface of an optical sensor of the optical sensor system of FIG. 1 to a control flow of a liquid and a measurement curve illustrating the spatial shift in the guided mode resonance with time during exposure of the sensing surface of the optical sensor to a flow of a solution which includes the same liquid, S. aureus bacteria in a concentration of 1e6 cfu/ml, and 12.5% TSB growth medium; and

FIG. 6E shows an optical micrograph of the sensing surface of the same optical sensor after growth of the biofilm following measurement of the data corresponding to the measurement curve of FIG. 6D.

### DETAILED DESCRIPTION OF THE DRAWINGS

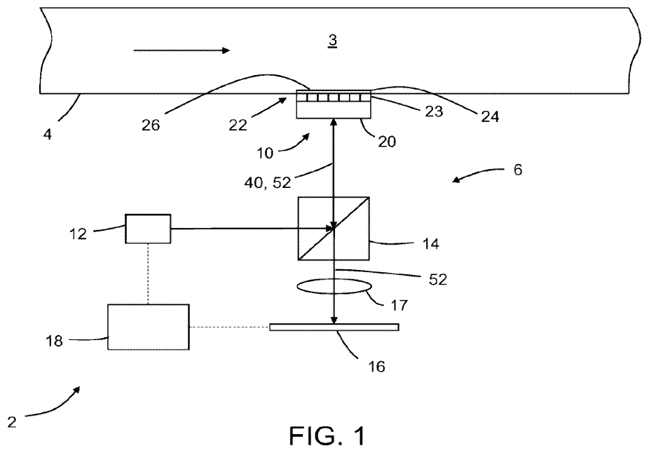

Referring initially to FIG. 1 there is shown a sensor system generally designated 2 in use detecting the deposition of material in the form of bacteria from a fluid 3 flowing in a fluid conduit 4. The fluid 3 may for example comprise a chemical, an ingredient, a foodstuff, a constituent of a foodstuff, a drink, a constituent of a drink, an ingredient or a constituent of a chemical or pharmaceutical composition, a biological fluid, or a bodily fluid. The sensor system 2 includes an optical sensor system 6 comprising an optical sensor 10, an optical source in the form of a laser diode 12, a beam-splitter 14, an image sensor 16 such as a CMOS or a CCD image sensor, and a lens 17. The sensor system 2 further includes a controller 18, which may be located with the optical sensor system 6 or remotely from the optical sensor system 6. As indicated by the dashed lines, the laser diode 12, the image sensor 16 and the controller 18 are configured for communication.

As will be described in more detail below, the optical sensor 10 is suitable for detecting the deposition of a material such as bacteria from the fluid 3 over a time period of greater than or equal to one hour, greater than or equal to one day, greater than or equal to one week, or greater than or equal to one month. It should be understood that the optical sensor 10 is also suitable for detecting the deposition of a material such as bacteria from the fluid 3 over a time period of less than one hour.

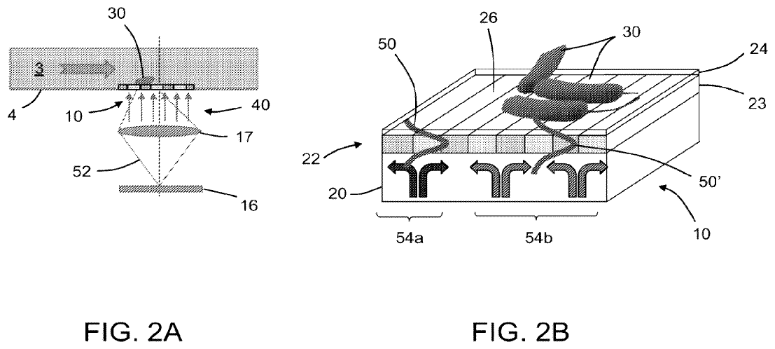

FIG. 2A shows part of the optical sensor system 6 in use detecting the deposition of bacteria 30 on the optical sensor 10 from the flow of fluid 3 through the fluid conduit 4. It should be understood that the laser diode 12 and the beam-splitter 14 have been omitted from FIG. 2A in the interest of clarity. FIG. 2B shows the optical sensor 10 and the bacteria 30 in more detail.

As shown most clearly in FIG. 2B, the optical sensor 10 includes a silica (SiO₂) substrate 20 and a chirped grating structure 22 formed on the substrate 20. The chirped grating structure 22 comprises one or more gratings 23 which are formed in silicon nitride (Si₃N₄) and which is disposed, for example formed, on the surface of the substrate 20.

The chirped grating structure 22 further includes an outer protective film or coating 24 which covers the one or more grating 23. The outer protective film or coating 24 takes the form of a 3 nm-thick layer of Al₂O₃ and an outermost 3 nm thick-layer of ZrO₂. The outer protective film or coating 24 is formed, for example, deposited using atomic layer deposition (ALD) so as to form a continuous pin-hole free protective film over the one or more gratings 23. The chirped grating structure 22 defines a sensing surface 26 for exposure to the flow of fluid 3 and for receiving material deposited from the flow of fluid 3.

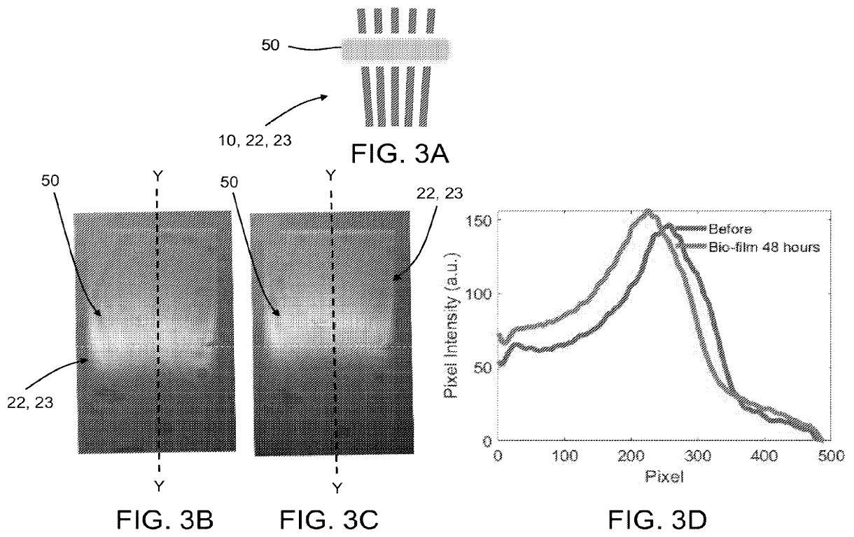

As shown schematically in FIG. 3A, the chirped grating structure 22 has a fan-out grating structure which has a grating period and/or a fill-factor which varies continuously in one direction over the chirped grating structure 22.

In use, the controller 18 controls the laser diode 12 and causes the laser diode 12 to emit light which is partially reflected by the beam-splitter 14 so as to direct a beam of light 40 through the substrate 20 of the optical sensor 10 and illuminate the whole of chirped grating structure 22, substantially the whole of the chirped grating structure 22, or an extended region of the chirped grating structure 22. As will be understood by one of ordinary skill in the art, the beam of light 40 excites one or more corresponding guided mode resonances 50 in one or more corresponding different regions of the chirped grating structure 22 thereby causing the one or more corresponding different regions of the chirped grating structure 22 to reflect one or more corresponding spatial portions 52 of the beam of light 40. A resonant wavelength of the guided mode resonances 50 depends on a refractive index of the fluid 3 to which the sensing surface 26 is exposed and/or a refractive index and a thickness of a material which is deposited on the sensing surface 26 from the flow of fluid 3. Specifically, as indicated by the different arrows 54a, 54b in FIG. 2B, the resonant wavelength of the one or more guided mode resonances 50 in the region of the chirped grating structure 22 where no bacteria is deposited is different from the resonant wavelength of the one or more guided mode resonances 50′ in the region of the chirped grating structure 22 where bacteria is deposited.

When the laser diode 12 has a fixed optical spectrum, the resonance condition is only met in a selected region of the chirped grating structure 22 resulting in the excitation of a guided mode resonance 50 in a spatially localised region of the chirped grating structure 22 as shown in FIG. 3A. As a thin film of bacteria forms on the sensing surface 26, the resonance condition on the sensing surface 26 is changed and the guided mode resonance 50 occurs in another region of the sensing surface 26 i.e. the guided mode resonance 50 moves spatially across the chirped grating structure 22 as a thin film of bacteria forms on the sensing surface 26. This spatial movement or shift in the guided mode resonance 50 is indicative of the formation of the thin film of bacteria. It should be understood that in general, for a beam of light 40 having a fixed optical spectrum, the positions of the one or more corresponding guided mode resonances 50 excited in the chirped grating structure 22 depend on a refractive index of the fluid 3 to which the sensing surface 26 is exposed and/or a refractive index and a thickness of a material which is deposited on the sensing surface 26 from the flow of fluid 3.

FIGS. 3B-3D illustrate the spatial movement or shift in the guided mode resonance 50 which is indicative of the formation of the thin film of bacteria. FIG. 3B shows an image of the chirped grating structure 22 and a guided mode resonance 50 excited during illumination of the chirped grating structure 22 with the beam of light 40 before exposure of the sensing surface 26 of the chirped grating structure 22 to a flow of broth in which bacteria is suspended. FIG. 3C shows an image of the chirped grating structure 22 and the guided mode resonance 50 excited during illumination with the beam of light 40 following a 48 hour exposure of the sensing surface 26 of the chirped grating structure 22 to a flow of broth in which bacteria is suspended. FIG. 3D shows plots of the intensity along the line Y-Y of the images of FIGS. 3B and 3C illustrating the spatial shift in the guided mode resonance 50 as a result of the exposure of the sensing surface 26 of the chirped grating structure 22 to the flow of media in which bacteria are suspended. Such a spatial shift may be detectable for bacteria concentrations in the fluid flow as low as 10³ cfu/ml.

An issue with the early stages of biofilm growth is that it does not occur uniformly, rather the bacteria initially nucleate in small clusters. Accordingly, the chirped grating structure 22 is configured so that the region in which the guided mode resonance 50 is excited is sufficiently large so that the effect of the bacteria 30 on the effective index of the guided mode resonance 50 is averaged over the guided mode resonance 50. Specifically, the chirped grating structure 22 is configured such that each corresponding guided mode resonance 50 has a dimension which is approximately equal to ten times a dimension of the bacteria 30. For example, if the bacteria 30 have a major dimension of 1-2 μm, the chirped grating structure 22 is configured such that each corresponding guided mode resonance 50 has a dimension of at 10-20 μm. It should be understood that the guided mode resonance 50 shown in FIG. 3A moves smoothly or progressively as the number of bacteria 30 deposited on the sensing surface 26 increases, thereby allowing the number of bacteria 30 deposited on the sensing surface 26 and/or the concentration of bacteria 30 in the fluid 3 to be accurately determined from the size of the spatial shift in the guided mode resonance 50. This is a consequence of the fact that the dimension of the guided mode resonance 50 is sufficiently large that the guided mode resonance 50 can interact with many bacteria 30. If, however, a dimension of the guided mode resonance 50 were comparable to a dimension of the bacteria 30, then the shift in the guided mode resonance 50 may be very localised leading to “hotspots” where the guided mode resonance 50 changes in some regions of the chirped grating structure 22 adjacent to the bacteria 30 but not in others and resulting in a guided mode resonance that is noisy and/or which jumps around. This may have the effect of reducing the accuracy with which the size of the spatial shift in the guided mode resonance 50 may be determined and of reducing the accuracy with which number of bacteria 30 deposited on the sensing surface 26 and/or the concentration of bacteria 30 in the fluid 3 may be determined. Conversely, if the dimension of the guided mode resonance 50 were much greater than ten times the dimension of the bacteria 30, the sensitivity of the sensor 10 may be reduced. Consequently, without wishing to be bound by theory, it is thought that configuring the chirped grating structure 22 such that the guided mode resonance 50 has a dimension which is approximately equal to ten times a dimension of the bacteria 30 represents a good compromise between accuracy and sensitivity. Such a chirped grating structure may, in particular, be well suited for measuring a sub-monolayer of bacteria and/or a sub-monolayer biofilm, for example over a time period of greater than or equal to one hour.

Moreover, it should be understood that the protective coating 24 provides both chemical and mechanical protection from the flow of fluid 3. This may be particularly important where the sensor 10 includes silicon and when the fluid comprises alkaline aqueous media such as an alkaline aqueous cell growth media because such alkaline aqueous media may degrade silicon. This may limit the operational lifetime of the sensor and rendering the sensor impractical for some applications. However, it has been found that using ALD to deposit the continuous pin-hole free protective coating 24 comprising a 3 nm-thick layer of Al₂O₃ and an outermost 3 nm thick-layer of ZrO₂ over the one or more gratings 23 may extend the operational lifetime of the sensor 10 to allow the optical sensor 10 to be used in various harsh environmental conditions over a time period of greater than or equal to one hour, greater than or equal to one day, greater than or equal to one week, or greater than or equal to one month. For example, the protective coating 24 may extend the operational lifetime of the sensor 10, wherein at least one of: the fluid is at a high temperature, a high pressure, and the fluid is corrosive. The protective coating 24 may also be important when detecting the deposition of a material on the sensing surface 26 from a fluid flow 3 which contains particulates in environments, such as industrial or manufacturing environments, where the particulates may cause abrasion, mechanical wear or damage of the sensing surface 26 of the chirped grating structure 22 over a time period of greater than or equal to one hour. The protective coating 24 may for example be important when detecting the deposition of a material on the sensing surface 26 from a fluid flow 3 which contains particulates and the fluid flow 3 and/or the optical sensor 10 are exposed to vibration over a time period of greater than or equal to one hour. In addition, the protective coating 24 may be important when detecting the deposition of a material on the sensing surface 26 from a fluid flow 3 which contains particulates in environments, such as industrial or manufacturing environments, where the fluid flow rate is high over a time period of greater than or equal to one hour.

The thickness of the protective film is selected so as to provide a sufficient degree of chemical and/or mechanical protection of the underlying one or more gratings 23, but not so thick so as to unduly reduce the sensitivity of the resonant wavelength of the optical sensor 10 to the refractive index of the fluid 3 to which the sensing surface 26 is exposed and/or to the refractive index and thickness of the material which is deposited on the sensing surface 26 from the flow of fluid 3.

It should be understood that the controller 18 may be used to detect, based on the relative position of the guided mode resonance 50 on the chirped grating structure 22 at the plurality of image capture times, a change in a refractive index of the fluid 3 to which the sensing surface 26 is exposed between any of the image capture times and/or a change in a refractive index and a thickness of a material which is deposited on the sensing surface 26 from the flow of fluid 3 between any of the image capture times. Additionally or alternatively, the controller 18 may be configured to determine, based on the relative position of the guided mode resonance 50 on the chirped grating structure 22 at the plurality of image capture times, a quantity representative of a magnitude of a change in a refractive index of the fluid 3 to which the sensing surface 26 is exposed between any of the image capture times and/or a quantity representative of a magnitude of a change in a refractive index and a thickness of a material which is deposited on the sensing surface 26 from the flow of fluid 3 between any of the image capture times. Additionally or alternatively, the controller 18 may be configured to determine, based on the relative positions of the guided mode resonance 50 on the chirped grating structure 22 at the plurality of image capture times in combination with calibration data, a magnitude of the change in a refractive index of the fluid 3 to which the sensing surface 26 is exposed between any of the image capture times and/or a magnitude of the change in a refractive index and a thickness of a material which is deposited on the sensing surface 26 from the flow of fluid 3 between any of the image capture times. The calibration data may for example comprise measurements of relative positions of the guided mode resonance 50 on the chirped grating structure 22 as a function of a known refractive index of a fluid to which the sensing surface 26 is exposed and/or measurements of relative positions of the guided mode resonance 50 on the chirped grating structure 22 as a function of a known refractive index and a known thickness of a material which is deposited on the sensing surface 26 from the flow of fluid.

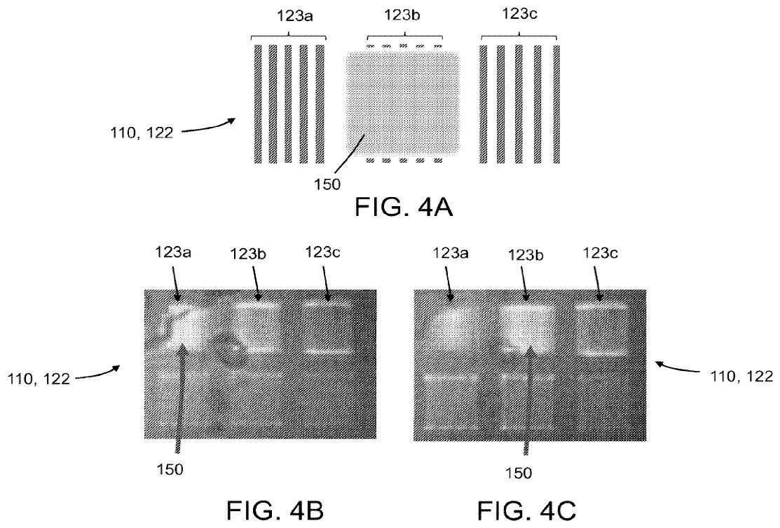

Referring now to FIG. 4A there is shown an alternative optical sensor 110 comprising an alternative chirped grating structure 122 for use in place of the optical sensor 10 of the sensor system 2 of FIG. 1. Unlike the continuously chirped fan-out grating structure 22 of FIG. 3A for the optical sensor 10, the alternative chirped grating structure 122 of FIG. 4A comprises a plurality of discrete gratings 123a, 123b, 123c, wherein each one of the discrete gratings 123a, 123b, 123c has a constant grating period which is different to the grating periods of each of the other discrete gratings 123a, 123b, 123c. Although not shown in FIG. 4A, it should be understood that each discrete grating 123a, 123b, 123c is formed in silicon nitride (Si₃N₄) and is disposed, for example formed, on the surface of a silica (SiO₂) substrate. Moreover, the chirped grating structure 122 further includes an outer protective film or coating like the coating 24 which covers the discrete gratings 123a, 123b, 123c. Like the chirped grating structure 22, the alternative chirped grating structure 122 also defines a sensing surface for exposure to the flow of fluid 3 and for receiving material deposited from the flow of fluid 3.

In use, all of the discrete gratings 123a, 123b, 123c of the alternative chirped grating structure 122 are illuminated with the beam of light 40 and a guided mode resonance 150 is excited in one of the discrete gratings 123a, 123b, 123c.

FIG. 4B shows an image of the alternative chirped grating structure 122 and a guided mode resonance 150 during illumination of the alternative chirped grating structure 122 with the beam of light 40 before exposure of the sensing surface of the alternative chirped grating structure 122 to a flow of media in which bacteria is suspended. FIG. 4C shows an image of the alternative chirped grating structure 122 and the guided mode resonance 150 during illumination of the alternative chirped grating structure 122 with the beam of light 40 following a 48 hour exposure of the sensing surface of the alternative chirped grating structure 122 to a flow of media in which bacteria is suspended. From FIGS. 4B and 4C, it may be appreciated that the guided mode resonance 150 shifts spatially from the discrete grating 123a to the discrete grating 123b as a result of the exposure of the sensing surface of the alternative chirped grating structure 122 to the flow of media in which bacteria is suspended. Such a spatial shift may be detectable for bacteria concentrations in the fluid flow as low as 103 cfu/ml.

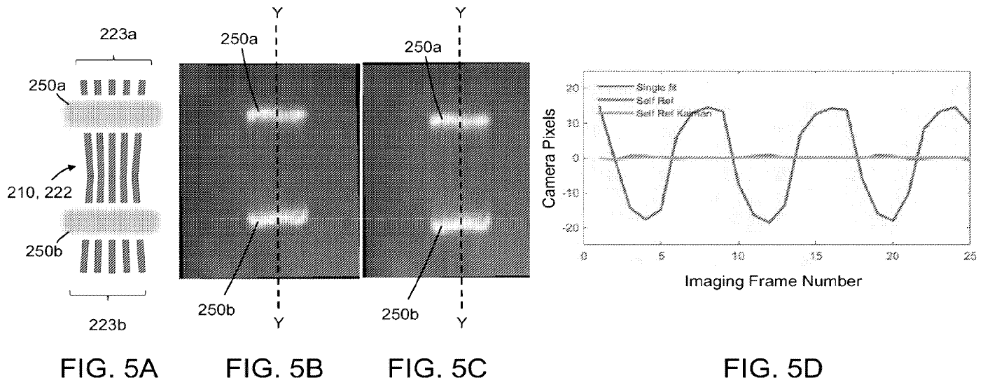

Referring now to FIG. 5A there is shown a further alternative optical sensor 210 comprising a further alternative chirped grating structure 222 for use in place of the optical sensor 10 of the sensor system 2 of FIG. 1 in an environment such as an industrial or manufacturing environment where the optical sensor 210 is exposed to mechanical vibration. As may be appreciated from FIG. 5A, the further alternative chirped grating structure 222 is a dual-chirped grating structure comprising first and second opposing chirped gratings 223a and 223b, wherein the first chirped grating 223a has a grating period and/or a fill-factor which increases in a first direction which extends away from the second chirped grating 223b and the second chirped grating 223b has a grating period and/or a fill-factor which increases in a second direction which extends away from the first chirped grating 223a, wherein the second direction is opposite to the first direction. Specifically, the first chirped grating 223a has a grating period and/or a fill-factor which increases continuously in the first direction and the second chirped grating 223b has a grating period and/or a fill-factor which increases continuously in the second direction. The dual-chirped grating structure 222 is symmetrical about a line of symmetry which extends between the first and second opposing chirped gratings 223a, 223b.

Although not shown in FIG. 5A, it should be understood that the first and second opposing chirped gratings 223a and 223b are formed in silicon nitride (Si₃N₄) and are disposed, for example formed, on the surface of a silica (SiO₂) substrate. Moreover, the chirped grating structure 222 further includes an outer protective film or coating like the coating 24 which covers the first and second opposing chirped gratings 223a and 223b. Like the chirped grating structure 22, the further alternative chirped grating structure 222 also defines a sensing surface for exposure to the flow of fluid 3 and for receiving material deposited from the flow of fluid 3.

In use, the first and second opposing chirped gratings 223a, 223b of the further alternative chirped grating structure 222 are illuminated with the beam of light 40 and guided mode resonances 250a, 250b are excited in opposing regions of the first and second opposing chirped gratings 223a, 223b respectively.

FIG. 5B shows an image of the chirped grating structure 222 and the guided mode resonances 250a, 250b during illumination of the chirped grating structure 222 with the beam of light 40 at a first instant in time in the presence of mechanical vibrations of the optical sensor including the chirped grating structure 222 relative to the remainder of the optical sensor system 6. FIG. 5C shows an image of the chirped grating structure 222 and guided mode resonances 250a, 250b during illumination with the beam of light 40 at a second instant in time in the presence of mechanical vibrations of the optical sensor relative to the remainder of the optical sensor system 6, wherein the first and second instants in time are separated by a time difference which is less than a time period of a single mechanical vibration and which is so small that there is no discernible change in a refractive index or a thickness of material deposited on the sensing surface of the chirped grating structure 222. By comparing FIGS. 5B and 5C, it may be seen that the mechanical displacement of the chirped grating structure 222 relative to the remainder of the optical sensor system 6, which occurs as a result of the mechanical vibrations of the chirped grating structure 222, causes a spatial shift of the guided mode resonances 250a, 250b together in the same vertical direction without a change in a separation of the guided mode resonances 250a, 250b.

The single fit trace in FIG. 5D is a plot of the vertical position of the peak intensity of one of the guided mode resonances 250a, 250b of FIGS. 5B and 5C along the line Y-Y as a function of time. The self-reference trace in FIG. 5D shows a plot of the vertical separation of the peak intensities of the guided mode resonances 250a, 250b of FIGS. 5B and 5C along line Y-Y as a function of time. The self-reference Kalman trace in FIG. 5D is an algorithmically predicted version of the self-reference trace of FIG. 5D. As may be appreciated from FIG. 5D, the self-reference Kalman trace is essentially zero, thereby indicating the feasibility of a method of detecting any changes in a refractive index and/or a thickness of a material deposited on the sensing surface of the chirped grating structure 222 in the presence of mechanical vibrations of the chirped grating structure 222. Specifically, the controller 18 may control the image sensor 16 so as to capture a plurality of images of the chirped grating structure 222 at a corresponding plurality of image capture times at a frequency which is greater than a frequency of any mechanical vibrations of the chirped grating structure 222 relative to the remainder of the optical sensor system 6. The controller 18 may then determine the separation of the guided mode resonances 250a, 250b on the image sensor 16 as a function of time and eliminate, or at least partially reduce, the effects of vibration by determining a rolling average of the determined separation of the guided mode resonances 250a, 250b over a time period of several vibrations to obtain a rolling average separation as a function of time. Any changes in the rolling average separation of the guided mode resonances 250a, 250b as a function of time may then be attributed to changes in a refractive index and/or a thickness of material deposited on the sensing surface of the chirped grating structure 222 from the flow of fluid 3.

As described above, the controller 18 may be configured to detect, based on the determined separation of the two guided mode resonances 250a, 250b or based on the determined rolling average value of the determined separation of the two guided mode resonances 250a, 250b, a change in a refractive index of the fluid 3 to which the sensing surface is exposed between any of the image capture times and/or a change in a refractive index and a thickness of a material which is deposited on the sensing surface from the flow of fluid 3 between any of the image capture times.

Additionally or alternatively, the controller 18 may be configured to determine, based on the determined separation of the two guided mode resonances 250a, 250b or based on the determined rolling average value of the determined separation of the two guided mode resonances 250a, 250b, a quantity representative of a magnitude of a change in a refractive index of the fluid 3 to which the sensing surface is exposed between any of the image capture times and/or a quantity representative of a magnitude of a change in a refractive index and a thickness of a material which is deposited on the sensing surface from the flow of fluid 3 between any of the image capture times.

Additionally or alternatively, the controller 18 may be configured to determine, based on calibration data in combination with the determined separation of the two guided mode resonances 250a, 250b or based on calibration data in combination with the determined rolling average value of the determined separation of the two guided mode resonances 250a, 250b, a magnitude of the change in a refractive index of the fluid 3 to which the sensing surface is exposed between any of the image capture times and/or a magnitude of the change in a refractive index and a thickness of a material which is deposited on the sensing surface from the flow of fluid 3 between any of the image capture times.

The calibration data may for example comprise measurements of the separation of the two guided mode resonances 250a, 250b on the chirped grating structure 222 as a function of a known refractive index of a fluid to which the sensing surface is exposed and/or measurements of the separation of the two guided mode resonances 250a, 250b on the chirped grating structure 222 as a function of a known refractive index and a known thickness of a material which is deposited on the sensing surface from the flow of fluid.

From the foregoing description of the optical sensor 210 it should be understood that the optical sensor 210 may be used to at least partially reduce the impact of, or to at least partially correct for the effects of, any misalignment of the optical sensor 210 relative to the laser diode 12 and the image sensor 16 which may be caused by mechanical vibrations and/or alignment drift over a time period of greater than or equal to one hour, for example in an environment such as an industrial processing or manufacturing environment. This may in turn improve the accuracy of detection of the deposition of material from the fluid 3 in the fluid conduit 4 over a time period of greater than or equal to one hour, for example in an environment such as an industrial processing or manufacturing environment.

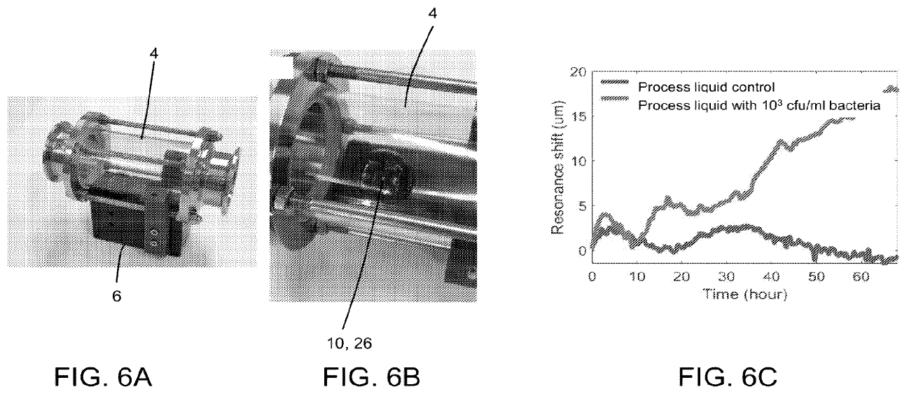

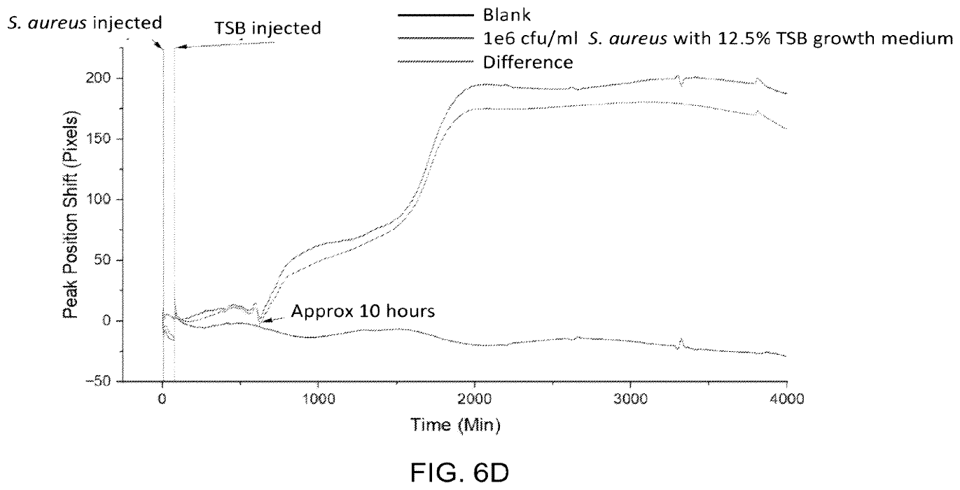

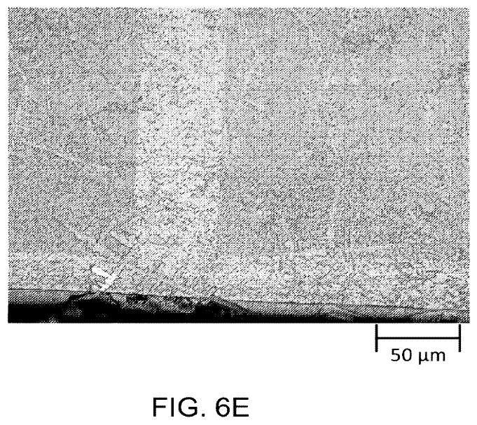

FIG. 6A shows an image of part of a fluid conduit system comprising the fluid conduit 4 in the form of a 5 cm diameter process pipe and the optical sensor system 6, wherein the optical sensor 10 is mounted relative to the fluid conduit 4 so that the sensing surface 26 is exposed to the flow of fluid 3 in the fluid conduit 4 for receiving material deposited from the flow of fluid 3.

FIG. 6B is an enlarged image of FIG. 6A highlighting the optical sensor 10 which is exposed directly to the fluid 3 in the 5 cm diameter process pipe 4.

FIG. 6C shows a reference curve illustrating the spatial shift in the guided mode resonance with time during exposure of the sensing surface 26 of the optical sensor 10 to a control flow of an industrially relevant process liquid in the 5 cm diameter process pipe of FIGS. 6A and 6B and a measurement curve illustrating the spatial shift in the guided mode resonance with time during exposure of the sensing surface 26 of the optical sensor 10 to a flow of the same process liquid including bacteria in a concentration of 10\hat{ }3 cfu/ml. A comparison of the traces of FIG. 6C, provides clear evidence for biofilm growth at the limit of detection of the optical sensor system 6.

FIG. 6D illustrates the spatial shift in the position of the peak intensity of the guided mode resonance with time during exposure of the sensing surface 26 of the optical sensor 10 to a flow of different solutions measured using the optical sensor 10 in the 5 cm diameter process pipe of FIGS. 6A and 6B. The reference curve (“blank”) represents the case where the sensing surface 26 of the optical sensor 10 is exposed to a control flow of a liquid at a known flow rate without any bacteria present and illustrates a variation in the position of the peak intensity of the guided mode resonance over time due to environmental factors e.g. due to temperature variations. The measurement curve (“1e6 cfu/ml S. aureus bacteria with 12.5% TSB growth medium”) represents the case where the sensing surface 26 of the same optical sensor 10 is subsequently exposed to a flow of a bacterial solution at the same known flow rate as the control flow, wherein the bacterial solution includes the same liquid as the control flow, and wherein the bacterial solution includes S. aureus bacteria in a concentration of 1e6 cfu/ml and 12.5% TSB growth medium. The difference curve (“Difference”) represents the difference between the measurement curve and the reference curve. A distinct shift of the peak position is observed after approximately 600 minutes, which continues until the biofilm thickness begins to exceed the sensitivity range of the optical sensor 10 at approximately 2000 minutes.

FIG. 6E shows an optical micrograph of the sensing surface 26 of the same optical sensor 10 after growth of the biofilm following measurement of the data corresponding to the measurement curve of FIG. 6D. The optical micrograph of FIG. 6E shows that bacteria has colonised the sensing surface 26. Furthermore, a live-dead stain was applied to the sensing surface 26 after biofilm growth and a fluorescence micrograph (not shown) of the sensing surface 26 was obtained which showed fluorescence emitted across the sensing surface 26 thereby demonstrating viability of the bacteria present across the sensing surface 26.

In a variant of the fluid conduit system described with reference to FIGS. 6A and 6B, the chirped grating structure comprises a measurement chirped grating structure and the optical sensor further comprises a reference chirped grating structure defining a reference sensing surface for exposure to the fluid and for receiving material deposited from the fluid, wherein the reference chirped grating structure comprises one or more gratings, wherein the one or more gratings of the reference chirped grating structure are nominally identical to the one or more gratings of the measurement chirped grating structure, wherein the reference chirped grating structure further comprises an outer protective film or coating which covers the one or more underlying gratings of the reference chirped grating structure and which defines the reference sensing surface, and wherein the outer protective films of the measurement and reference chirped grating structures are configured so that a position of a guided mode resonance in the measurement chirped grating structure is more sensitive, and preferably much more sensitive, to changes in the thickness and/or refractive index of the material to which the sensing surface is exposed and a position of a guided mode resonance in the reference chirped grating structure is less sensitive, and preferably much less sensitive, to changes in the thickness and/or refractive index of the material to which the reference sensing surface is exposed. Specifically, the outer protective film or coating of the measurement chirped grating structure may be thinner than the outer protective film or coating of the reference chirped grating structure so that a position of a guided mode resonance in the measurement chirped grating structure is more sensitive, and preferably much more sensitive, to changes in the thickness and/or refractive index of the material to which the sensing surface is exposed and a position of a guided mode resonance in the reference chirped grating structure is less sensitive, and preferably much less sensitive, to changes in the thickness and/or refractive index of the material to which the reference sensing surface is exposed.

In use, the sensing surface of the measurement chirped grating structure and the reference sensing surface of the reference chirped grating structure are exposed to the same fluid (e.g. bacterial solution), for example the same flow of fluid or the same static fluid and guided mode resonances are excited in both the measurement and reference chirped grating structures. One of ordinary skill in the art will understand that the peak positions of the guided mode resonances excited in the measurement and reference chirped grating structures are both sensitive to temperature changes. Consequently, the difference between the peak positions of the guided mode resonances excited in the measurement and reference chirped grating structures may be considered to be representative of the thickness and/or the refractive index of the material (e.g. biofilm) deposited on the sensing surface of the measurement chirped grating structure.

In a further variant of the fluid conduit system described with reference to FIGS. 6A and 6B, the chirped grating structure comprises a measurement chirped grating structure and the optical sensor further comprises a reference chirped grating structure defining a reference sensing surface for exposure to the fluid and for receiving material deposited from the fluid, wherein the reference chirped grating structure comprises one or more gratings, wherein the one or more gratings of the reference chirped grating structure are nominally identical to the one or more gratings of the measurement chirped grating structure, wherein the reference chirped grating structure further comprises an outer protective film or coating which covers the one or more underlying gratings of the reference chirped grating structure and which defines the reference sensing surface, and wherein the measurement chirped grating structure does not comprise any outer protective film or coating covering the one or more gratings of the measurement chirped grating structure such that the one or more gratings of the measurement chirped grating structure define the sensing surface. One of ordinary skill in the art will understand that, in use, the peak positions of guided mode resonances excited in the measurement chirped grating structure and the reference chirped grating structure are both sensitive to temperature changes. Consequently, the difference between the peak positions of the guided mode resonances excited in the measurement chirped grating structure and the reference chirped grating structure may be considered to be representative of the thickness and/or the refractive index of the material (e.g. biofilm) deposited on the sensing surface of the measurement chirped grating structure.

One of ordinary skill in the art will also understand that various modifications are possible to any of the methods described above. For example, although the chirped grating structures 22, 122, 222 described above include one or more silicon nitride (Si₃N₄) gratings disposed, for example formed, on a silica (SiO₂) substrate, the one or more gratings and the substrate may be formed from different materials, provided the one or more gratings comprise, or are formed from, a material which has a higher refractive index than the material of which the substrate comprises, or is formed, and which has a higher refractive index than the material to be detected. Thus, the substrate may comprise, or be formed from, silica (SiO₂) and the one or more gratings may comprise, or be formed from, a material which has a higher refractive index than silica (SiO₂) and which has a higher refractive index than the material to be detected. Conversely, the one or more gratings may comprise, or be formed from, silicon nitride (Si₃N₄) and the substrate may comprise or be formed form a material which has a lower refractive index than silicon nitride (Si₃N₄). In other embodiments, the one or more gratings may comprise, or be formed from, silicon.

Although the chirped grating structures 22, 122, 222 described above are configured so that the corresponding guided mode resonances have a dimension which is approximately equal to, or which is equal to, ten times the dimension of the dielectric particles to be detected, other chirped grating structures may be configured such that each corresponding guided mode resonance has a dimension which is greater than or equal to a dimension of the dielectric particles and less than or equal to twenty times the dimension of the dielectric particles or such that each corresponding guided mode resonance has a dimension which is greater than or equal to twice a dimension of the dielectric particles and less than or equal to fifteen times the dimension of the dielectric particles. For example, the chirped grating structure may be configured such that each corresponding guided mode resonance has a dimension of at least 5 μm, at least 10 μm, at least 20 μm, at least 50 μm, or at least 100 μm.

Although the chirped grating structures 22, 122, 222 described above are 1D chirped grating structures, in an alternative optical sensor, the chirped grating structure may comprise a 2D chirped grating structure.

Although the protective coating 24 takes the form of a 3 nm-thick layer of Al₂O₃ and an outermost 3 nm thick-layer of ZrO₂ deposited using atomic layer deposition (ALD) so as to form a continuous pin-hole free protective film over the one or more gratings 23, 123a, 123b, 123c, 223a, 223b other continuous pin-hole free protective coatings are possible. For example, the protective film may comprise, or be formed from, a single material. The protective film may comprise a single layer such as a single layer of Al₂O₃ or a single layer of ZrO₂. The protective film may comprise a plurality of inorganic of organic layers. The protective film may comprise a first layer of a first material and a second layer of a second material. The protective film may comprise a plurality of layers of a first material alternating with a plurality of layers of a second material. The protective film may comprise more than two different materials.

The protective coating may be deposited using ALD or an alternative deposition technique.

Although the optical sensor system 6 comprises an optical source in the form of a laser diode 12, any kind of narrow-band, quasi-monochromatic, monochromatic, or coherent optical source may be used. For example, a filtered LED may be used.

One of skill in the art will also understand that although the optical sensor system 6 is described above as comprising the optical sensor 10, the laser diode 12, the beam-splitter 14, the CMOS or a CCD image sensor 16, and the lens 17, other optical sensor system embodiments are possible. For example, the optical sensor system may comprise an optical sensor like the optical sensor 10, a narrow-band optical source of any kind, and an image sensor of any kind, without any need for a beam-splitter or a lens. For example, the optical sensor system may comprise a collimated narrow-band optical source which directs a collimated beam of light at the optical sensor and the image sensor may capture a plurality of near-field images of a sensing surface of the optical sensor. For example, the collimated narrow-band optical source may direct a collimated beam of light at the optical sensor at an acute angle relative to a surface normal of the optical sensor. The one or more spatial positions of one or more excited guided mode resonances may be determined from the captured near-field images of the sensing surface of the optical sensor and deposition of material on the sensing surface from the flow of fluid to which the sensing surface is exposed may be determined from a change in a spatial position of the one or more guided mode resonances.

The optical sensor may be configured for use in detecting the deposition of bacteria of any kind. The optical sensor may be configured for use in detecting the deposition of a dielectric material of any kind. The optical sensor may be configured for use in detecting the deposition of one or more particles such as one or more dielectric particles. The optical sensor may be configured for use in detecting the deposition of a metal. The optical sensor may be configured for use in detecting the deposition of a contaminant such as dirt, sand, grit or the like. The optical sensor may be configured for use in detecting the deposition of an organic or inorganic material. The optical sensor may be configured for use in detecting the deposition of one or more proteins. The optical sensor may be configured for use in detecting the deposition of one or more biological organisms, micro-organisms, and/or molecules. The optical sensor may be configured for use in detecting the deposition of one or more cells.

The optical sensor may be configured for use in detecting the deposition of a biofilm of any kind. For example, the optical sensor may be configured for use in detecting the deposition of one or more cells, micro-organisms and/or bacteria embedded in extracellular matrix of extracellular polymeric substances.

The optical sensor may comprise a layer of one or more binding agents, binding materials or binding molecules such as one or more antibodies on the sensing surface of the optical sensor. The use of a layer of one or more binding agents may help to bind biological organisms, molecules, cells and/or bacteria to the sensing surface of the optical sensor, thereby increasing the sensitivity and specificity of the optical sensor to biological organisms, molecules, cells and/or bacteria.

Although the optical sensor embodiments described above have been described in the context of detecting the deposition of a material from a flow of fluid in a fluid conduit, it should be understood that any of the optical sensor embodiments may be used for the detection of the deposition of a material from a flow of fluid of any kind. Any of the optical sensor embodiments may be used for the detection of the deposition of a material from a static fluid such as a static fluid in a fluid conduit. Any of the optical sensor embodiments may be used for the detection of the deposition of a material from a fluid which is stored or contained in a fluid vessel, a fluid reservoir, or a fluid tank.

The optical sensor may be configured for use in detecting the deposition of a material from a fluid comprising one or more chemicals, one or more ingredients, one or more food stuffs, one or more constituents of a food stuff, one or more drinks, one or more constituents of a drink, one or more ingredients or constituents of a chemical or pharmaceutical composition, one or more biological fluids, or one or more bodily fluids.

The optical sensor may be configured for use in detecting the deposition of a material such as a wax material or a hydrate from a hydrocarbon fluid.

Although the disclosure has been described in terms of preferred embodiments as set forth above, it should be understood that these embodiments are illustrative only and that the claims are not limited to those embodiments. Those skilled in the art will be able to make modifications and alternatives to the described embodiments in view of the disclosure which are contemplated as falling within the scope of the appended claims. Each feature disclosed or illustrated in the present specification may be incorporated in any embodiment, whether alone or in any appropriate combination with any other feature disclosed or illustrated herein. In particular, one of ordinary skill in the art will understand that one or more of the features of the embodiments of the present disclosure described above with reference to the drawings may produce effects or provide advantages when used in isolation from one or more of the other features of the embodiments of the present disclosure and that different combinations of the features are possible other than the specific combinations of the features of the embodiments of the present disclosure described above.

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Use of the term “comprising” when used in relation to a feature of an embodiment of the present disclosure does not exclude other features or steps. Use of the term “a” or “an” when used in relation to a feature of an embodiment of the present disclosure does not exclude the possibility that the embodiment may include a plurality of such features.

The use of reference signs in the claims should not be construed as limiting the scope of the claims.

1. An optical sensor for use in detecting the deposition of material from a fluid over a time period of greater than or equal to one hour, the optical sensor comprising:
a chirped grating structure, the chirped grating structure defining a sensing surface for exposure to the fluid and for receiving material deposited from the fluid,
wherein the chirped grating structure is configured such that when the chirped grating structure is illuminated with a beam of light, one or more corresponding guided mode resonances are excited in one or more corresponding different regions of the chirped grating structure thereby causing the one or more corresponding different regions of the chirped grating structure to reflect one or more corresponding spatial portions of the beam of light,
wherein the positions of the one or more corresponding different regions of the chirped grating structure in which the one or more corresponding guided mode resonances are excited depend on a refractive index of a material to which the sensing surface is exposed and/or a refractive index and a thickness of a material which is deposited on the sensing surface from the fluid.

2. The optical sensor of claim 1, wherein the chirped grating structure comprises a plurality of different grating structures, each grating structure having a different grating period in one or two directions and/or a different fill-factor in one or two directions.

3. The optical sensor of claim 1, wherein the chirped grating structure has a grating period and/or a fill-factor which varies in one or two directions over at least part of the chirped grating structure.

4. The optical sensor of claim 1, wherein the chirped grating structure comprises a dual-chirped grating structure comprising first and second opposing chirped gratings, wherein the first chirped grating has a grating period and/or a fill-factor which increases in a first direction which extends away from the second chirped grating and the second chirped grating has a grating period and/or a fill-factor which increases in a second direction which extends away from the first chirped grating, wherein the second direction is opposite to the first direction.

5. The optical sensor of claim 4, wherein the dual-chirped grating structure is symmetrical about a line of symmetry which extends between the first and second opposing chirped gratings.

6. The optical sensor of claim 1, wherein the material to be detected comprises one or more particles such as one or more dielectric particles and/or one or more bacteria and the chirped grating structure is configured such that each corresponding guided mode resonance has a dimension which is greater than or equal to a dimension of the particles and less than or equal to twenty times the dimension of the particles, which is greater than or equal to twice a dimension of the particles and less than or equal to fifteen times the dimension of the particles, which is approximately equal to, or which is equal to, ten times the dimension of the particles.

7. The optical sensor of claim 1, wherein the chirped grating structure is configured such that each corresponding guided mode resonance has a dimension of at least 5 μm, at least 10 μm, at least 20 μm, at least 50 μm, or at least 100 μm.

8. The optical sensor of claim 1, wherein the optical sensor comprises a substrate, wherein the chirped grating structure is disposed on, formed on, or defined in, a surface of the substrate and wherein the chirped grating structure comprises one or more gratings which are formed in a material which is disposed on, or formed on, the surface of the substrate.

9. The optical sensor of claim 8, wherein the chirped grating structure comprises an outer protective film which defines the sensing surface and which covers the one or more gratings.

10. The optical sensor of claim 8, wherein the chirped grating structure comprises a measurement chirped grating structure and the optical sensor further comprises a reference chirped grating structure defining a reference sensing surface for exposure to the fluid and for receiving material deposited from the fluid, wherein the reference chirped grating structure comprises one or more gratings, wherein the one or more gratings of the reference chirped grating structure are nominally identical to the one or more gratings of the measurement chirped grating structure, wherein the reference chirped grating structure further comprises an outer protective film which covers the one or more underlying gratings of the reference chirped grating structure and which defines the reference sensing surface, and wherein the outer protective films of the measurement and reference chirped grating structures are configured so that a position of a guided mode resonance in the measurement chirped grating structure is more sensitive to changes in the thickness and/or refractive index of the material to which the sensing surface is exposed and a position of a guided mode resonance in the reference chirped grating structure is less sensitive to changes in the thickness and/or refractive index of the material to which the reference sensing surface is exposed.

11. The optical sensor of claim 8, wherein the chirped grating structure comprises a measurement chirped grating structure and the optical sensor further comprises a reference chirped grating structure defining a reference sensing surface for exposure to the fluid and for receiving material deposited from the fluid, wherein the reference chirped grating structure comprises one or more gratings, wherein the one or more gratings of the reference chirped grating structure are nominally identical to the one or more gratings of the measurement chirped grating structure, wherein the reference chirped grating structure further comprises an outer protective film which covers the one or more underlying gratings of the reference chirped grating structure and which defines the reference sensing surface, and wherein the measurement chirped grating structure does not comprise any outer protective film covering the one or more underlying gratings of the measurement chirped grating structure such that the one or more gratings of the measurement chirped grating structure define the sensing surface.

12. An optical sensor system for use in detecting the deposition of material from a fluid over a time period of greater than or equal to one hour, the optical sensor system comprising:
the optical sensor as claimed in claim 1;
an optical source for generating the beam of light for illuminating the chirped grating structure; and
an image sensor for capturing an image of the chirped grating structure when the chirped grating structure is illuminated by the beam of light.

13. A fluid conduit system comprising:
a fluid conduit containing a fluid; and
the optical sensor as claimed in claim 1,
wherein the optical sensor is mounted relative to the fluid conduit so that the sensing surface is exposed to the fluid in the fluid conduit for receiving material deposited from the fluid in the fluid conduit.

14. A fluid vessel system comprising:
a fluid vessel containing a fluid; and
the optical sensor as claimed in claim 1,
wherein the optical sensor is mounted relative to the fluid vessel so that the sensing surface is exposed to the fluid in the fluid vessel for receiving material deposited from the fluid in the fluid vessel.

15. A sensor system for use in detecting the deposition of material from a fluid over a time period of greater than or equal to one hour, the sensor system comprising:
the optical sensor system as claimed in claim 12; and
a controller configured to:
control the optical source and the image sensor so that the image sensor captures a plurality of images of the chirped grating structure at a corresponding plurality of image capture times when the chirped grating structure is illuminated by the beam of light;
determine a position of each of the one or more guided mode resonances on the chirped grating structure at each of the image capture times; and
detect, based on the relative positions of each of the one or more guided mode resonances on the chirped grating structure at the plurality of image capture times, a change in a refractive index of a material to which the sensing surface is exposed between any of the image capture times and/or a change in a refractive index and a thickness of a material which is deposited on the sensing surface from the fluid between any of the image capture times.

16. The sensor system of claim 15, wherein the controller is configured to control the image sensor so that the image sensor captures the plurality of images of the chirped grating structure at the corresponding plurality of image capture times over a time period of greater than or equal to one minute, greater than or equal to one hour, greater than or equal to one day, greater than or equal to one week, or greater than or equal to one month and/or wherein the controller is configured to determine, based on the relative positions of each of the one or more guided mode resonances on the chirped grating structure at the plurality of image capture times, a quantity representative of a magnitude of a change in a refractive index of a material to which the sensing surface is exposed between any of the image capture times and/or a quantity representative of a magnitude of a change in a refractive index and a thickness of a material which is deposited on the sensing surface from the fluid between any of the image capture times.

17. The sensor system of claim 15, wherein the controller is configured to determine, based on the relative positions of each of the one or more guided mode resonances on the chirped grating structure at the plurality of image capture times in combination with calibration data, a magnitude of the change in a refractive index of a material to which the sensing surface is exposed between any of the image capture times and/or a magnitude of the change in a refractive index and a thickness of a material which is deposited on the sensing surface from the fluid between any of the image capture times.

18. A method for use in detecting the deposition of material from a fluid over a time period of greater than or equal to one hour, the method comprising:
exposing a sensing surface of a chirped grating structure to the fluid so that the sensing surface can receive material deposited from the fluid;
illuminating the chirped grating structure with a beam of light so as to excite one or more guided mode resonances in one or more corresponding different regions of the chirped grating structure thereby causing the one or more corresponding different regions of the chirped grating structure to reflect one or more corresponding spatial portions of the beam of light; and
capturing a plurality of images of the chirped grating structure at a corresponding plurality of image capture times when the chirped grating structure is illuminated by the beam of light.

19. The method of claim 18, comprising:
determining a position of each of the one or more guided mode resonances on the chirped grating structure at each of the image capture times; and
detecting, based on the relative positions of each of the one or more guided mode resonances on the chirped grating structure at the plurality of image capture times, at least one of:
a change in a refractive index of a material to which the sensing surface is exposed between any of the image capture times;
a change in a refractive index and a thickness of a material which is deposited on the sensing surface from the fluid between any of the image capture times
a quantity representative of a magnitude of a change in a refractive index of a material to which the sensing surface is exposed between any of the image capture times; or
a quantity representative of a magnitude of a change in a refractive index and a thickness of a material which is deposited on the sensing surface from the fluid between any of the image capture times.

20. (canceled)

21. The method of claim 18, comprising determining, based on the relative positions of each of the one or more guided mode resonances on the chirped grating structure at the plurality of image capture times in combination with calibration data, a magnitude of the change in a refractive index of a material to which the sensing surface is exposed between any of the image capture times and/or a magnitude of the change in a refractive index and a thickness of a material which is deposited on the sensing surface from the fluid between any of the image capture times. and, optionally, wherein the

22. The method of claim 18, comprising capturing the plurality of images of the chirped grating structure at a corresponding plurality of image capture times over a time period of greater than or equal to one day, greater than or equal to one week, or greater than or equal to one month and/or comprising capturing the plurality of images of the chirped grating structure at a corresponding plurality of image capture times at a frequency which is greater than, a frequency of any mechanical vibrations of the chirped grating structure relative to an optical source used to illuminate the chirped grating structure and/or relative to an image sensor used to capture the plurality of images of the chirped grating structure.

23. (canceled)

24. The method of claim 18, comprising determining a separation of two guided mode resonances on the chirped grating structure at each image capture time of the plurality of image capture times.

25. (canceled)

26. (canceled)

27. The method of claim 24, comprising determining, based on calibration data in combination with the determined separation of the two guided mode resonances or based on the calibration data in combination with the determined rolling average value of the determined separation of the two guided mode resonances, a magnitude of the change in a refractive index of a material to which the sensing surface is exposed between any of the image capture times and/or a magnitude of the change in a refractive index and a thickness of a material which is deposited on the sensing surface from the fluid between any of the image capture times.

28. The optical sensor of claim 1, wherein at least one of:
the material to be detected comprises a dielectric material;
the material to be detected comprises one or more particles such as one or more dielectric particles;
the material to be detected comprises a metal;
the material to be detected comprises a contaminant.
the material to be detected comprises organic or inorganic material;
the material to be detected comprises one or more proteins;
the material to be detected comprises one or more biological organisms, micro-organisms, and/or molecules;
the material to be detected comprises one or more cells;
the material to be detected comprises bacteria;
the material to be detected comprises an extracellular matrix of extracellular polymeric substances;
the material to be detected comprises a biofilm;
the fluid comprises one or more chemicals, one or more ingredients, one or more food stuffs, one or more constituents of a food stuff, one or more drinks, one or more constituents of a drink, one or more ingredients or constituents of a chemical or pharmaceutical composition, one or more biological fluids, or one or more bodily fluids;
the fluid comprises a hydrocarbon fluid; and
the material to be detected comprises wax or one or more hydrates.

29. The method of claim 18, wherein at least one of:
the material to be detected comprises a dielectric material;
the material to be detected comprises one or more particles;
the material to be detected comprises a metal;
the material to be detected comprises a contaminant.
the material to be detected comprises organic or inorganic material;
the material to be detected comprises one or more proteins;
the material to be detected comprises one or more biological organisms, micro-organisms, and/or molecules;
the material to be detected comprises one or more cells;
the material to be detected comprises bacteria;
the material to be detected comprises an extracellular matrix of extracellular polymeric substances;
the material to be detected comprises a biofilm;
the fluid comprises one or more chemicals, one or more ingredients, one or more food stuffs, one or more constituents of a food stuff, one or more drinks, one or more constituents of a drink, one or more ingredients or constituents of a chemical or pharmaceutical composition, one or more biological fluids, or one or more bodily fluids;
the fluid comprises a hydrocarbon fluid; or
the material to be detected comprises wax or one or more hydrates.
